(19) United States
(12) Patent Application Publication
(10) Pub. No.: US 2010/0218112 A1
(43) Pub. Date: Aug. 26, 2010

(54) TRACKING WEB PAGE CLICK INFORMATION

(75) Inventors: Musun Park, Seoul (KR); Dongwoo Kim, Seoul (KR)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/394,726

(22) Filed: Feb. 27, 2009

(30) Foreign Application Priority Data
Feb. 20, 2009 (KR) 10-2009-0014374

(51) Int. Cl. G06F 3/00

(52) U.S. Cl. 715/745

(57) ABSTRACT

Methods and apparatus are described for tracking web page click information. The web page click information includes user information representing one or more users who visited a corresponding web page. The web page click information also includes click location information representing one or more click locations selected by the one or more users in the corresponding web page. Embodiments of the invention enable selection of a web page and generation of a representation of the web page click information for the selected web page. The representation includes at least some of the click location information for that page.

### BACKGROUND OF THE INVENTION

The present inventions relates to techniques for tracking web page click information of a user who has visited a web page.

The Internet is now a fundamental part of today's lifestyle. The number of people using the Internet for economic and leisure activities has significantly increased. Accordingly, a significant number of websites now exists and website administrators are constantly concerned in managing them more effectively and efficiently. As to the method of effectively managing a website, the information on how a user who has visited a particular web page navigates in the particular web page is very useful. Such information can be practically used in many areas such as designing user interfaces in a web page, analyzing navigation patterns of a user, verifying effectiveness of advertising, establishing marketing strategies, etc. Thus, mechanisms that can track web page click information (e.g., how a user navigates in a web page of a website, how a user navigates among a plurality of web pages, etc.) are important.

As one mechanism for tracking web page click information, a user link tracking method is currently available. If a user visits a website, then an access log related to the visit is recorded in a web server as a file. The user link tracking method tracks web page click information using the access log file recorded in a web server. However, if the link information does not exist at a location where a user makes a click, then the click information cannot be provided. Further, when a user clicks a flash image or photo, the exact coordinate values cannot be provided. Thus, in order to provide the web page click information, there is a need for mechanisms that can provide web page click information more precisely and independently from the existence of link.

### SUMMARY OF THE INVENTION

According to the present invention, a variety of techniques are enabled by which web page click information of a user who has visited a website may be tracked.

In accordance with an embodiment of the present invention, there is provided a system for tracking web page click information. The system includes at least one storage device and one or more computing device. The at least one storage device stores web page click information therein for each of a plurality of web pages. The web page click information includes user information representing one or more users who visited the corresponding web page. The web page click information also includes click location information representing one or more click locations selected by the one or more users in the corresponding web page. Each of the one or more click locations is defined by coordinate values on a frame of reference of the corresponding web page. The one or more computing devices are configured to facilitate selection of one of the web pages and generate a representation of the web page click information for the selected web page. The representation includes at least some of the click location information.

In accordance with another embodiment of the present invention, there is provided a method of tracking web page click information. The method includes presenting a web page in an interface on a user device, generating click location information representing one or more click locations selected in the web page via the user device, and transmitting the click location information to a remote device for storage with user information representing a user associated with the user device. Each of the one or more click locations is defined by coordinate values on a frame of reference of the corresponding web page.

In accordance with yet another embodiment of the present invention, there is provided a method of tracking web page click information. According to the method, web page click information for each of a plurality of web pages is stored. The web page click information includes user information representing one or more users who visited the corresponding web page. Further, the web page click information also includes click location information representing one or more click locations selected by the one or more users in the corresponding web page. Each of the one or more click locations is defined by coordinate values on a frame of reference of the corresponding web page. The target web page selection interface is then provided to enable selection of one of the web pages. Thereafter, a representation of the web page click information for the selected web page is generated. The representation includes at least some of the click location information.

A further understanding of the nature and advantages of the present invention may be realized by reference to the remaining portions of the specification and the drawings.

### BRIEF DESCRIPTION OF THE DRAWINGS

FIG. 1 shows a simplified representation of a computing environment in which embodiments of the present invention may be implemented.

FIG. 2 shows a configuration of a user terminal which may be used to implement embodiments of the present invention.

FIG. 3 shows a configuration of a function module 216 of the user terminal 110 in accordance with one embodiment of the present invention.

FIG. 4 shows a data file 400 in accordance with one embodiment of the present invention.

FIG. 5 shows a functional block diagram of a server system 120 in accordance with one embodiment of the present invention.

FIG. 6 shows a configuration of a function module 600 of an administrator terminal 130 in accordance with one embodiment of the present invention.

FIG. 7 illustrates data in the data file analyzed by a navigation pattern analysis module 620 in accordance with one embodiment of the present invention.

FIGS. 8a and 8b show data in the data file analyzed by the navigation route analysis module 630 in accordance with one embodiment of the present invention.

FIG. 9 shows an operation of one embodiment of the present invention from the perspective of a user terminal 110.

FIG. 10 shows an operation of one embodiment of the present invention from the perspective of an administrator terminal 130.

FIG. 11 shows a display screen to illustratively describe embodiments of a web page 1100 in accordance with the present invention.

FIGS. 12-14 show screens to illustratively describe embodiments of providing analysis results in accordance with the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

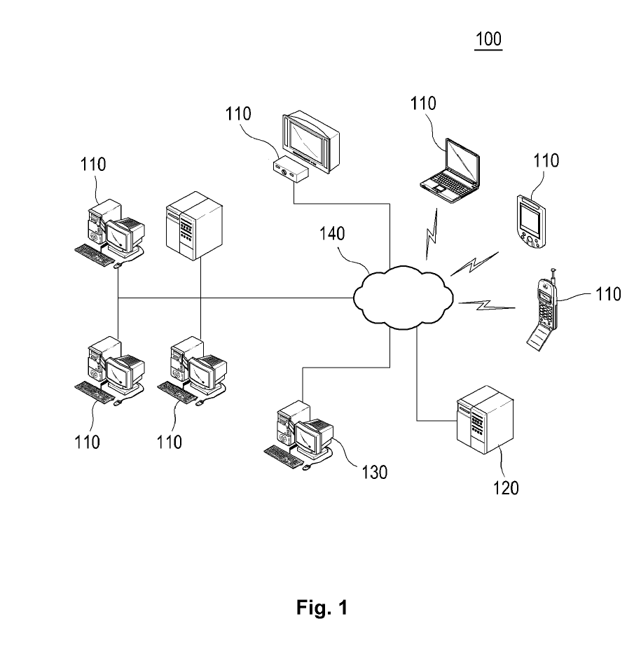

As mentioned above, various embodiments of the invention provide mechanisms which track web page click information through a website provided in a network such as, for example, the Web. FIG. 1 shows a simplified configuration of a computing environment in which embodiments of the present invention may be implemented. Referring to FIG. 1, a network system 100 includes a plurality of user terminals 110, a server system 120 and an administrator terminal 130. Although both the user terminal 110 and the administrator terminal 130 operate as a client with regard to the server system 120, the subjects using the devices differ from each other. That is, while the user terminal 110 is used by users enjoying Internet surfing, the administrator terminal 130 is used by an administrator who desires to obtain web page click information of the users who have visited a web page.

The user terminals 110 and the administrator terminal 130 may include any type of computers (e.g., desktop, laptop, tablet, etc.), media computing platforms (e.g., cable, satellite set top boxes, digital video recorders, etc.), handheld computing devices (e.g., PDAs, e-mail clients, etc.), cell phones or any other type of computing or communication platforms. The server system 120 may include a server device or decentralized server devices, and may include mainframe computers, mini computers, super computers, personal computers, or combinations thereof. Further, although FIG. 1 illustrates only one server system 120, a plurality of server systems 120 may also be used without departing from the scope of the present invention. The user terminals 110 and the server system 120 may communicate with each other through a network 140. The network 140 may comprise, e.g., wired networks such as LANs (local area networks), WANs (wide area networks), MANs (metropolitan area networks), ISDNs (Intergrated Service Digital Networks), etc. as well as wireless networks such as wireless LANs, CDMA, Bluetooth, and satellite communication networks, etc. without limiting the scope of the present invention.

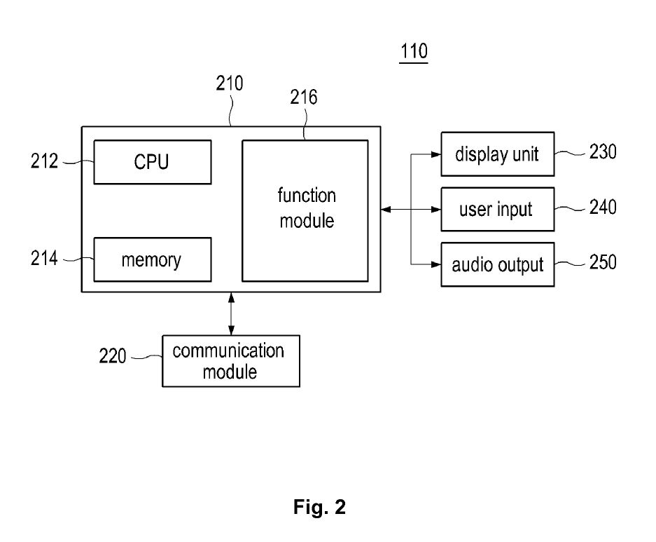

FIG. 2 shows a configuration of a user terminal in accordance with one embodiment of the present invention. Referring to FIG. 2, the user terminal 110 includes a computing platform 210 that can accommodate and execute software application programs as well as a communication module 220 that includes hardware and software for communication through the network 140. The computing platform 210 generally includes a CPU (central processing unit) 212 that may include, for example, microprocessors, digital signal processors (DSPs) and/or microcontrollers, as well as a memory 214 that may include volatile and/or nonvolatile memories. The computing platform 210 interacts with various input/output devices.

The computing platform 210 may also include a function module 216 to support desired functions. The function module 216 may include hardware and/or software, and may share the hardware and/or software with other function modules (not shown) as necessary or appropriate. Although FIG. 2 shows the function module 216 separated from other elements, the function module 216 need not be physically separated. For example, the function module 216 may be embodied as a software program stored in the memory 214. The function module 216 may exchange data with other function modules or cooperate with them in any of a variety of ways. The user terminal 110 may also include user interfaces to provide information to and receive inputs from users, which may include a display unit 230 such as computer monitors, a user input unit 240 such as a keyboard or a mouse, an audio output unit 250 such as speakers, etc.

The memory 214 may include, for example, a Read Only Memory (ROM), EPROM (Erasable and Programmable ROM), EEPROM (Electrically EPROM), etc. In addition, the memory 214 may be mounted in a detachable manner to allow replacement or upgrades as necessary or appropriate. That is, the memory 214 may also include other types of storage devices such as a SmartMedia® card, CompactFlash® card, Memory Stick®, MultiMediaCard®, DataPlay disc®, SecureDigital® card, etc.

A communication module 220 provides logical connections to at least one remote device as a single module or via a wired or wireless communication protocol. The communication module 220 may be coupled to the computer platform 110. In one embodiment, a communication protocol (either wired or wireless) may be implemented by employing a digital interface protocol such as a serial port, parallel port, PS/2 port, universal serial bus (USB) link, firewire or IEEE 1394 link, or wireless interface connection such as an infrared interface, BlueTooth®, ZigBee, high-definition multimedia interface (HDMI), high-bandwidth digital content protection (HDCP), wireless fidelity (Wi-Fi), local area network (LAN), wide area network (WAN) or the like. In some embodiments, the communication module 220 may include a modem to communicate through mobile communications systems such as Global System for Mobile Communications (GSM), Global Positioning System (GPS), Digital Mobile Multimedia (DMB), Code Division Multiple Access (CDMA), High-Speed Down Link Packet Access (HSDPA), Wi-Bro Wireless Broadband and the like. It will be appreciated that the connection methods described in the present disclosure are only examples and other means of establishing a communications link between the devices/computers may be used.

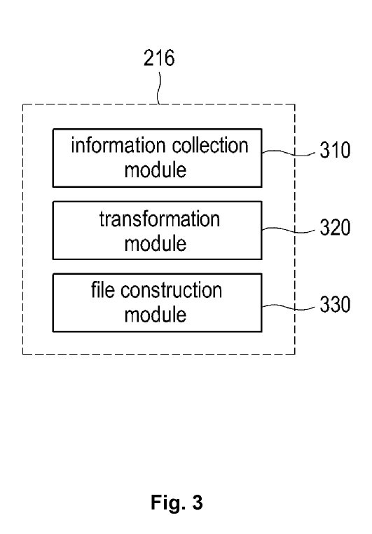

FIG. 3 shows a configuration of the function module 216 in accordance with one embodiment of the present invention. Referring to FIG. 3, the function module 216 may include an information collection module 310, a transformation module 320 and a file construction module 330. The information collection module 310 collects user information on at least one user who has visited a particular web page at least once and web page click information on the particular web page for the at least one user. In one embodiment, user information may be obtained from a cookie of the website. In one embodiment, web page click information may include click coordinate value, current link, click link, previous link, click object coordinate value, time, etc. It will be appreciated by those skilled in the art that the user information and web page click information can be obtained in many different ways. For example, a separate device for collecting such information may be provided outside of the user terminal 110. That is, instead of collecting the web page click information on the user terminal, the relevant data for each click event may be transmitted from the user terminal for collection elsewhere, e.g., server system 120. This might be effected, for example, using mechanisms embedded in the page on which the user is clicking.

The “click coordinate value” indicates the coordinate value of the location clicked by a user (“click location”) on a web page which is currently provided on the screen of the user terminal 110. The “current link” means the URL (Uniform Resource Locator) of the web page which is currently provided on the screen of the user terminal 110. The “click link” means the link URL of the click location. If a link does not exist at the click location, then the click link is an empty value. The “previous link” means the web page URL of the previous web page where the user has visited right before the current web page. Similarly, if the user does not visit any web page before the current one, then the previous link is an empty value. The “click object coordinate value” means the coordinate value at the upper left side of HTML object including the click location. The “time” means the timestamp value when the user clicks a location.

In one embodiment, the web page click information may be obtained using JavaScript. Examples of JavaScript codes for obtaining web page click information (click coordinate values, click link and previous link) are provided below. It will be appreciated by those skilled in the art that the JavaScript codes suggested below are only examples and various methods may be used for obtaining web page click information without departing from the scope of the present invention.

Click X=event.clientX

Click Y=event.clientY

Previous link=document.referer

Click link=clicked_object.href

The transformation module 320 is configured to transform the click coordinate values to relative coordinate values. The click coordinate values collected by the information collection module 310 are values on the screen of the user terminals 110. Thus, depending on web browser environments of user terminals 110, the values of the click locations become different even if the user clicks the same location. Thus, it is necessary to transform the click coordinate values obtained from the plurality of user terminals 110 to ones on a common coordinate system. Accordingly, the concept of a relative coordinate value is employed with various embodiments of the present invention. Using the relative coordinate values, the click coordinate values obtained from the plurality of user terminals 110 can be displayed on a common coordinate system. An example of an algorithm for transforming click coordinate values to relative coordinate values according to a particular embodiment of the invention is as follows.

Relative X = (larger one between horizontal size of browser and horizontal
size of document)/2 − horizontal scroll size + Click Y
Relative Y = vertical scroll size + Click Y
[The term “Click Y” indicates the click y coordinate values]

In this approach, a browser size and scrolling status are considered in transforming click coordinate values into relative coordinate values. It should be noted that the “Relative Y” value is determined by adding the “Click Y” value to vertical scroll size, given that the y-coordinate is fixed independently of the browser size. In one embodiment, this algorithm may be embodied by the source program suggested below. However, it will be appreciated by those skilled in the art that the following source program is merely an example and the algorithm may be implemented using other various methods.

var event = checkEvent(event);
// return MouseEvent object
cw = document.documentElement.clientWidth;
// size of browser width
sw = document.body.scrollWidth;
// size of document width
if(cw<sw) cw=sw;
//if browser width is smaller than the document width, then setting the
document width as the value of cw
cw = Math.floor(cw/2);
// dividing cw by 2
sl = document.documentElement.scrollLeft;
// horizontal scroll size
st = document.documentElement.scrollTop;
// vertical scroll size
x = sl+event.clientX;
//adding click x-coordinate value to horizontal scroll size
y = st+event.clientY;
// adding click y-coordinate value to vertical scroll size
x = cw−x;
// calculating relative coordinates

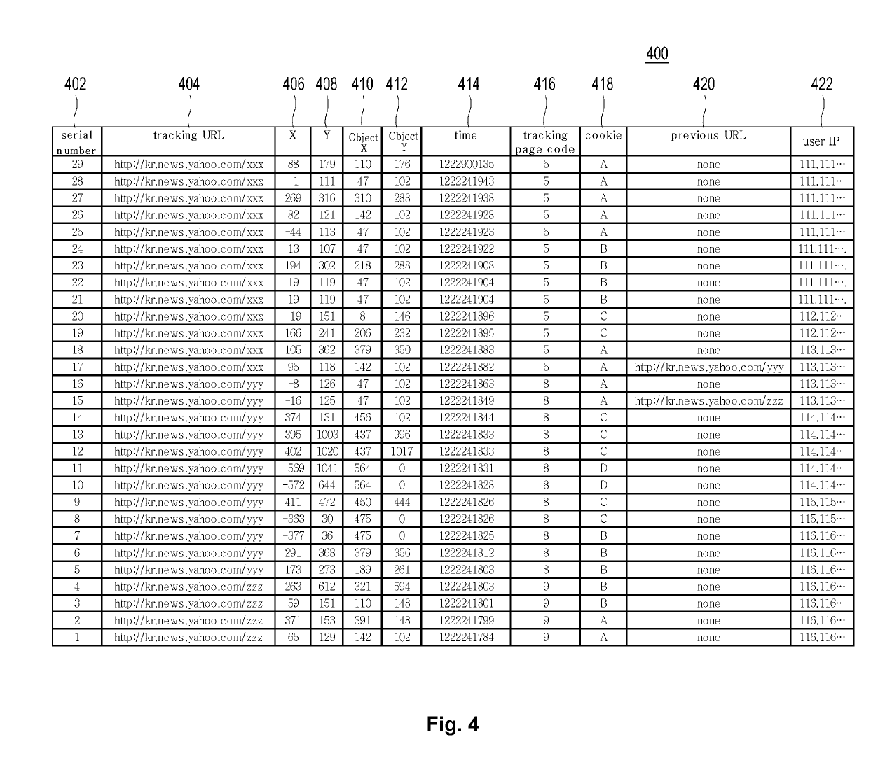

The file construction module 330 provides a data file based on the information collected by the information collection module 310 and the relative coordinate values obtained by the transformation module 320. FIG. 4 shows an example of a data file 400 provided by the file construction module 330 in accordance with one embodiment of the present invention. Referring to FIG. 4, the data file 400 includes fields indicating a serial number 402, track URL 404, x-coordinate value 406, y-coordinate value 408, object x-coordinate value 410, object y-coordinate value 412, time 414, tracking page code 416, cookie 418, previous URL 420, and user IP 422. In the data file 400 shown in FIG. 4, x-coordinate value 406 and y-coordinate value 408 are relative x-coordinate and relative y-coordinate values, respectively. Object x-coordinate value 410 and object y-coordinate value 412 indicate the coordinate values of the HTML object including the click location. For example, if there is a table column of “<td> test </td>” among HTML table tags, then the information on how many times the location is clicked by users can be provided using the upper left side of <td> tag area. The tracking page code 416 is to distinguish the current page among a plurality of web pages to be tracked. The cookie 418 is a temporary file containing information which is created when a user connects to a particular web page. The previous URL 420 means the URL of the web page where the user has visited before the current web page. IP filed 422 indicates the user's current IP address. It is appreciated by those skilled in the art that the data file 400 shown in FIG. 4 is only an example and the fields included in the data file can vary or be modified without departing from the scope of the present invention.

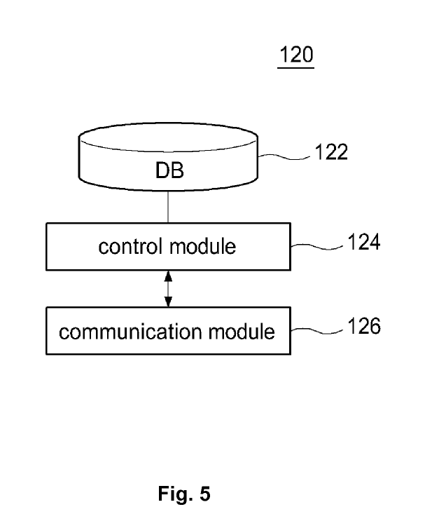

FIG. 5 shows a functional block diagram of the server system 120 in accordance with one embodiment of the present invention. Referring to FIG. 5, the server system 120 includes a database 122, a control module 124, and a communication module 126 providing a communication interface with the network 140. In one embodiment, the database 122 is configured to store at least one data file 400 transferred or derived from the user terminal 110 and various types of data necessary for the management of the server system 120. Further, the control module 124 may be configured to search the data in the database 122 in response to an analysis request from the administrator terminal 130 and transfer the searched data through the communication module 126. The administrator terminal 130 may be explained later. For this functionality, the control module 124 may include CPU (not shown) and memory (not shown). The CPU may be configured to use the HTTPS protocol, the FTP protocol, or any other applicable protocols to process the requests and responses, all of which are included in the present invention. The memory may include, for example, a Read Only Memory (ROM), EPROM (Erasable and Programmable ROM), EEPROM (Electrically EPROM), etc. In addition, the memory may be mounted in a detachable manner to allow replacement or upgrades as necessary or appropriate.

The administrator terminal 130 is configured to retrieve the data file from the server system 120 and provide an analysis result based on the data in the data file. Most of the basic structures of the administrator terminal 130 may be the same as those of the user terminal 110 shown in FIG. 2. Thus, detailed explanations on such structures are omitted herein. On the other hand, a function module 600 included in the administrator terminal 130 will be explained.

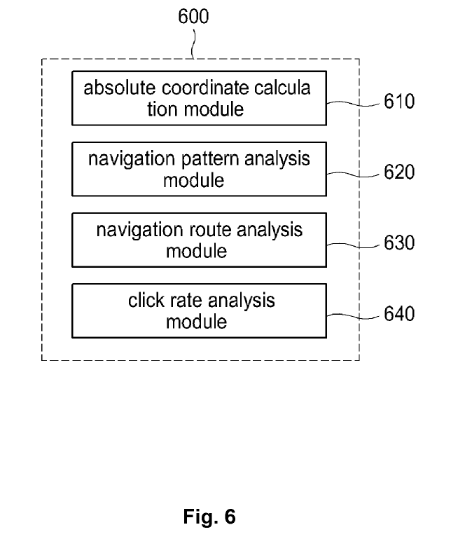

FIG. 6 shows a structure of the function module 600 of the administrator terminal 130 in accordance with one embodiment of the present invention. Referring to FIG. 6, the function module 600 includes an absolute coordinate calculation module 610, a navigation pattern analysis module 620, a navigation route analysis module 630 and a click rate analysis module 640. The absolute coordinate calculation module 610 transforms the relative coordinate values transferred from the server system 120 to absolute coordinate values. As used herein, the “absolute coordinate value” is a concept which is employed in order to properly transform the relative coordinate values transferred from the server system 120 based on the web browser environment of the administrator terminal 130. By using the absolute coordinate values, the click location on the user terminal 110 can be properly displayed on a screen of the administrator terminal 130. An algorithm for transforming relative coordinate values to absolute coordinate values according to a particular embodiment of the invention is provided below.

Absolute X = Relative X − (larger one between horizontal size of browser
and horizontal size of document)/2 + horizontal scroll size
Absolute Y: the value transferred from the server system
[The term “Relative Y” indicates the relative y-coordinate values]

In the example above, since the y-coordinate is fixed independently of the browser size, the value transferred from the server system 120 is used as it is without a separate calculation. Further, it will be appreciated by those skilled in the art that the approach illustrated above is merely an example and the transformation can be performed in accordance with a variety of techniques.

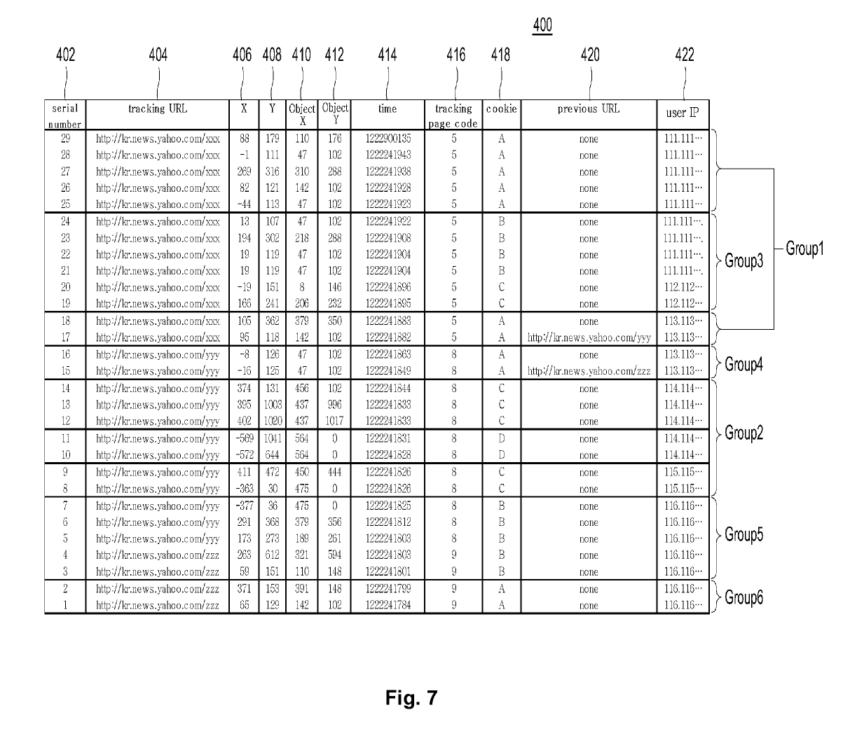

The navigation pattern analysis module 620 is configured to track the information on how the user navigates in a web page as time passes. In one embodiment, the navigation pattern analysis module 620 classifies the data in the data file transferred from the server system 120 so that the data having the same user information and the same tracking URL are grouped together, and sequentially sorts the classified data. In accordance with one embodiment of the present invention, FIG. 7 illustrates that the data in the data file 400 shown in FIG. 4 are classified as multiple groups by the navigation pattern analysis module 620. Referring to FIG. 7, the data in “Group 1” has the cookie of “A” and the track URL of “http://kr.news.yahoo.com/xxx,” while the data in “Group 2” has the cookie of “C” and the track URL of “http://kr.news.yahoo.com/yyy.”

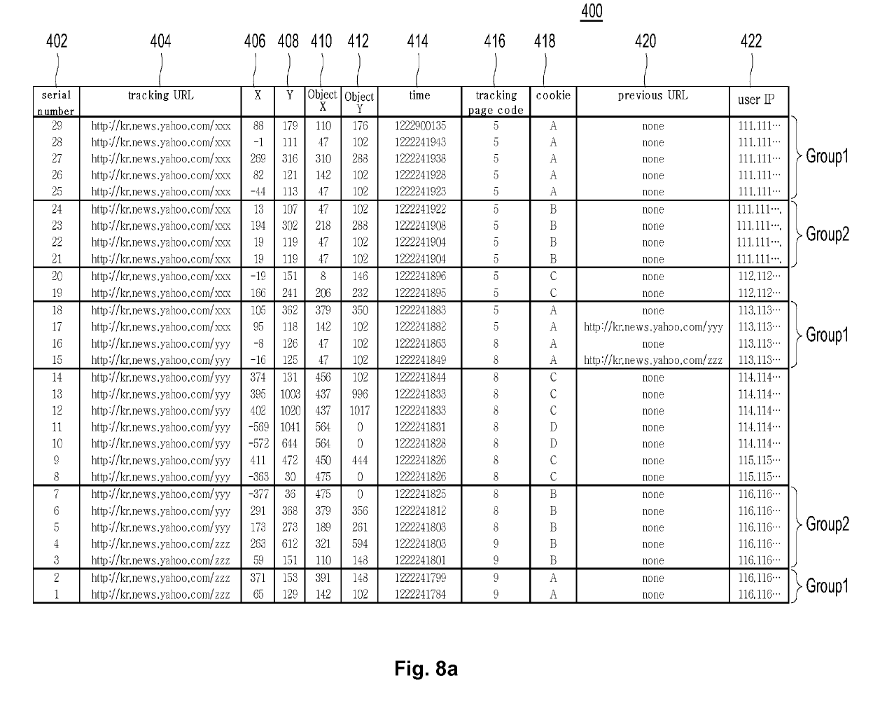

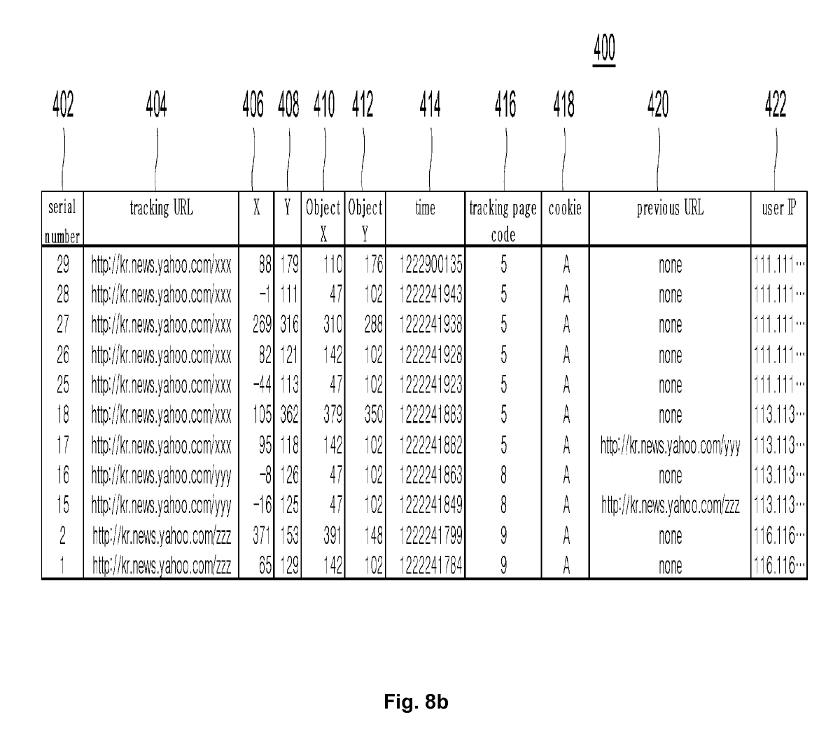

Referring now back to FIG. 6, the navigation route analysis module 630 is configured to track web pages clicked by the user through using link information. In one embodiment, the navigation route analysis module 630 selects at least one data file from the server system 120 and classifies the data in the data file transferred from the server system 120 so that the data having the same user information are grouped together. Further, the navigation route analysis module 630 sequentially sorts the data which is classified for each user. Based on the previous URL information, the information on which web pages a particular user visits as time passes can be obtained. According to one embodiment that employs the data file 400 shown in FIG. 4, the navigation route analysis module 630 classifies the data in the data file 400 based on the cookie 418 and sorts the data in a sequential manner. Referring to FIG. 8a, the data are classified into Groups 1, 2, 3 and 4 based on the cookie value. Further, FIG. 8b shows that the data in Group 1 are sorted in a sequential order. Referring to the previous URL field 420, it is understood that the user sequentially moves from “http://kr.news.yahoo.com/zzz,” to “http://kr.news.yahoo.com/yyy,” to “http://kr.news.yahoo.com/xxx” as time passes.

Returning to FIG. 6, the click rate analysis module 640 counts the numbers (“click number”) indicating how many times users click a particular click location in a particular web page. Further, the click rate analysis module 640 calculates the click rate based on the click number of the particular location. According to one embodiment, the click rate may be determined as follows.

Click Rate=(click number for the particular location)/(total click numbers that the users made in the web page)

In one embodiment, the click rate analysis module 640 counts the click numbers using the object x-coordinate and object y-coordinate values 410 and 420 in the date file 400. The specific embodiments relating to how the results obtained from the navigation pattern analysis module 620, navigation route analysis module 630, and click rate calculation module are presented on the administrator terminal 130 will be explained later.

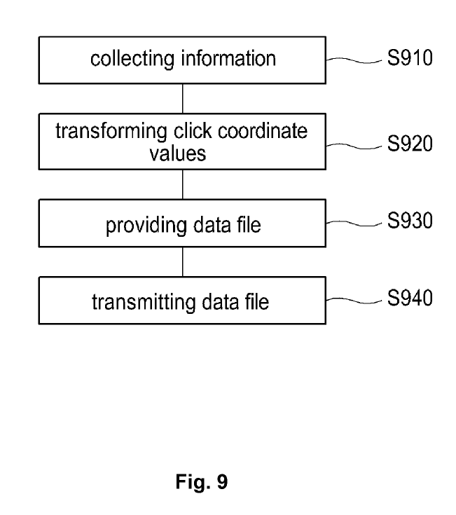

FIG. 9 illustrates the operation of one embodiment of the present invention from the perspective of a user terminal 110. Referring to FIG. 9, the user terminal 110 collects the user information on at least one user who has visited a particular web page at least once and web page click information on the particular web page for the at least one user (step 910). In one embodiment, the user information may be obtained from a cookie of the website. In one embodiment, the web page click information may include click coordinate values, current link, click link, previous link, click object coordinate values, time, etc. In one embodiment, the operation of collecting user information and the web page click information may be automatically performed in a predetermined interval. After collecting the user information and the web page click information, the collected click coordinate values are transformed to relative coordinate values (step 920). The example of an algorithm for transforming the click coordinate values into relative coordinate values described above may be employed. At the step 930, the data file including the transformed relative coordinate values is provided. It should be noted that FIG. 4 shows an example of a data file 400 which may be provided at step 930 in accordance with one embodiment of the invention. The provided data file is transferred to the server system 120 (step 940).

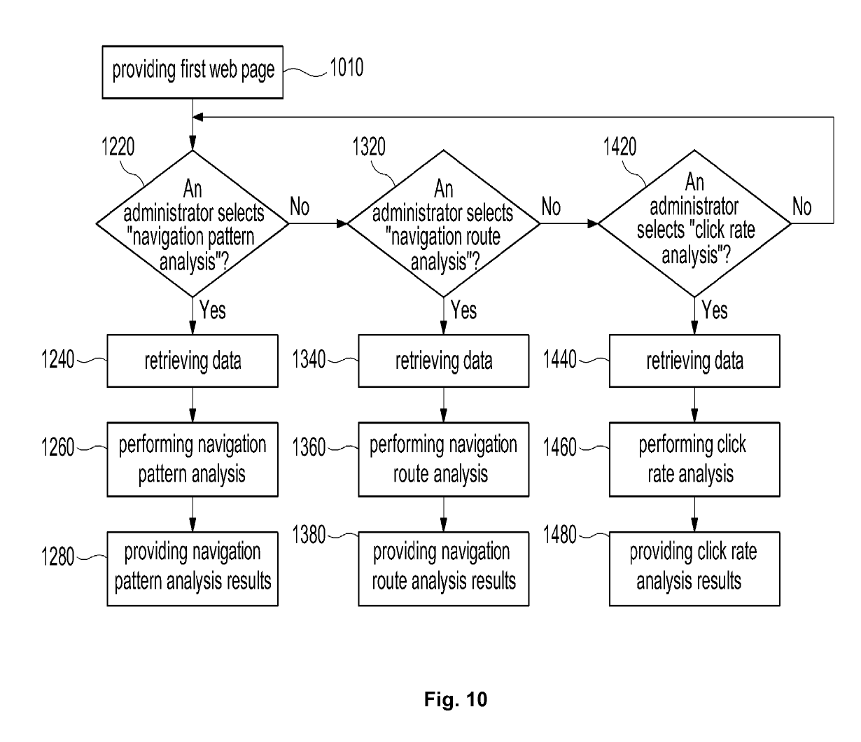

FIG. 10 illustrates the operation of one embodiment of the present invention from the perspective of an administrator terminal 130. Referring to FIG. 10, the administrator terminal 130 provides a web page providing a method of tracking web page click information in accordance with one embodiment of the present invention. Although it is not shown in FIG. 10, the administrator terminal 130 may be embodied to further perform an authentication process to verify whether a user connected to the web page is authorized prior to providing the web page to the administrator.

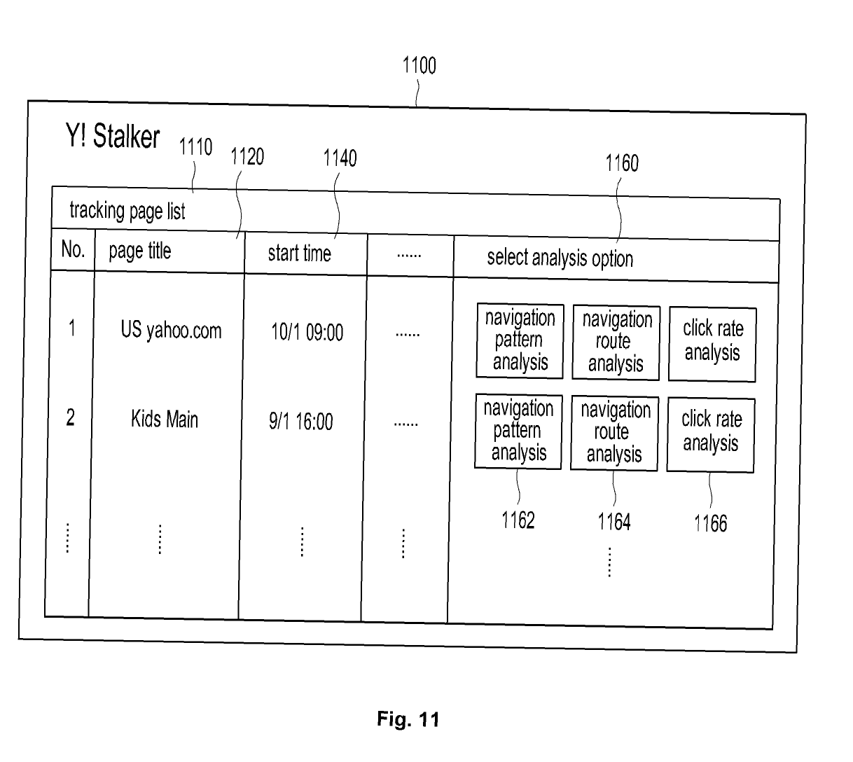

FIG. 11 illustrates a web page interface with which a method of tracking web page click information may be facilitated in accordance with one embodiment. Referring to FIG. 11, the web page 1100 includes the tracking page list 1110 indicating the information of web pages being tracked. According to a particular embodiment, the tracking page list 1110 includes a “page title” field 1120, a “start time” field 1140, and a “select analysis option” field 1160. The administrator may select a target page to be tracked by clicking one of the web pages in the “page title” field 1120. Further, by clicking one of the buttons 1162, 1164, or 1166, the administrator may select an analysis option to analyze the tracking results of the target page. That is, each one of the analysis options indicates a guideline for generating web page click information in the selected target web page. In FIG. 11, as an analysis option for analyzing the tracking results, “navigation pattern option,” “navigation route option” and “click rate option” are displayed. It will be understood that the web page interface shown in FIG. 11 has been provided only for an illustrative purpose and those skilled in the art may construct such an interface using a variety of other fields. Further, although it is shown that the “select analysis option” field includes the buttons 1162, 1164, and 1166 in FIG. 11, it will be appreciated by those skilled in the art that the functionality can be realized using icons, text, photographs, figures, or any of a wide variety of interface controls other than buttons.

Returning to FIG. 10, the administrator terminal 130 determines which analysis option is selected for the selected target web page (steps 1220, 1320 and 1420). Cases in which the administrator selects one of the navigation pattern option, the navigation route option, and the click rate option are discussed below.

If the administrator selects the navigation pattern option, then the administrator terminal 130 may determine that the navigation pattern analysis request was made (step 1220). Accordingly, the administrator terminal 130 retrieves data from the server system 120 (step 1240). Then, the administrator terminal 130 sorts the data having the same user code and the same tracking URL in a sequential order (step 1260). At the step of 1280, the administrator terminal 130 displays the sorted data on a screen of the administrator terminal 130 in such a manner that the administrator can recognize how the clicked positions by the user are changed as time passes.

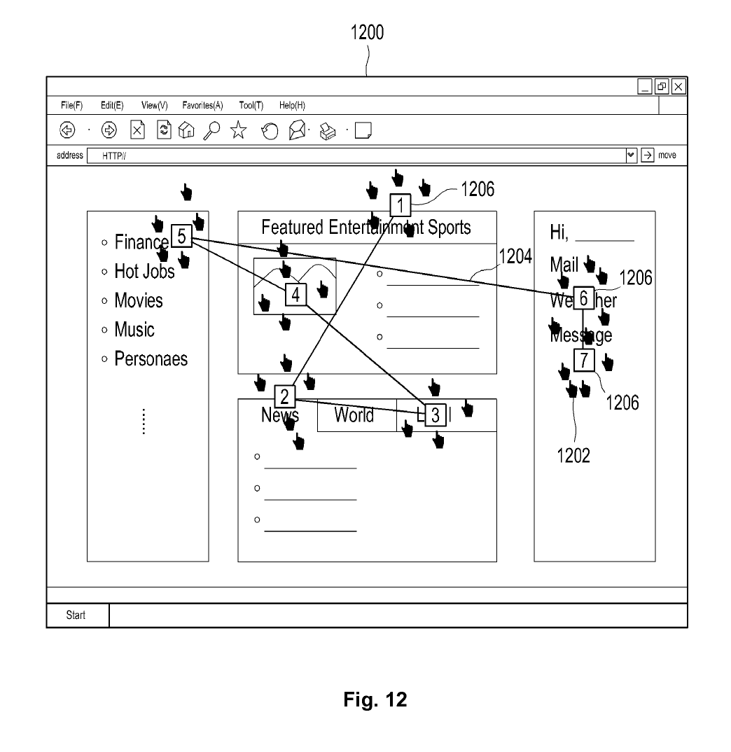

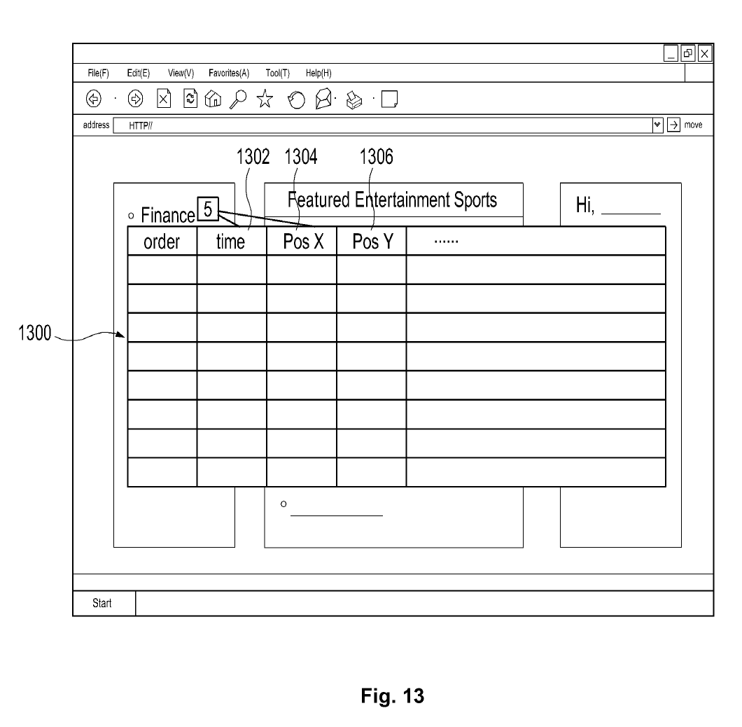

FIG. 12 illustrates one embodiment of the web page displayed on the screen of the administrator terminal 130 at the step 1280. Referring to FIG. 12, icons shaped like fingers 1202 are displayed at the position clicked by the users. Further, on the screen 1200, the positions clicked by the same user are connected through the line 1204. Further, in FIG. 12, the number 1206 may be provided together, which indicates the order that the particular user clicks the location. Additionally or alternatively as shown in FIG. 13, a table 1300 may be further provided, which contains the information on each of the click locations positioned on the line 1204. In one embodiment, the table 1300 includes the fields of time 1302, x-coordinate values 1304, and y-coordinate values 1306. In such a case, the administrator can obtain more exact information on the time when the click location is clicked by the user, what the exact values of the click location are, etc. Those skilled in the art may employ a variety of other methods to display the results of tracking web page click information without departing from the scope of the present invention.

Referring back to FIG. 10, where it is determined that the administrator does not select the navigation pattern analysis at the step 1220, the process proceeds to the step 1320 and determines whether the navigation route analysis is selected. If so, the process proceeds to the step 1340 where the administrator terminal 130 retrieves data from the server system 120. Then, the administrator terminal 130 sorts the data having the same user code in a sequential order (step 1360). At the step of 1380, the administrator terminal 130 displays the sorted data on a screen of the administrator terminal 130 in such a manner that the administrator can recognize the navigation route of the user as time passes.

Lastly, if it is determined that that the administrator does not select the navigation pattern analysis or the navigation route analysis at the steps 1220 and 1320, respectively, the process proceeds to the step 1420 and determines whether the click rate option is selected. If so, the process proceeds to the step 1440 where the administrator terminal 130 retrieves data from the server system 120. Then, the administrator terminal 130 counts the number of clicks that the users made for each click location and calculates the click rate based on the counted number (step 1460). In one embodiment, the click rate may be calculated according to the above-described equation. At the step of 1480, the administrator terminal 130 displays the counted number of clicks and the calculated click rate on a screen of the administrator terminal 130 in such a manner that the administrator can recognize the navigation route of the user as time passes.

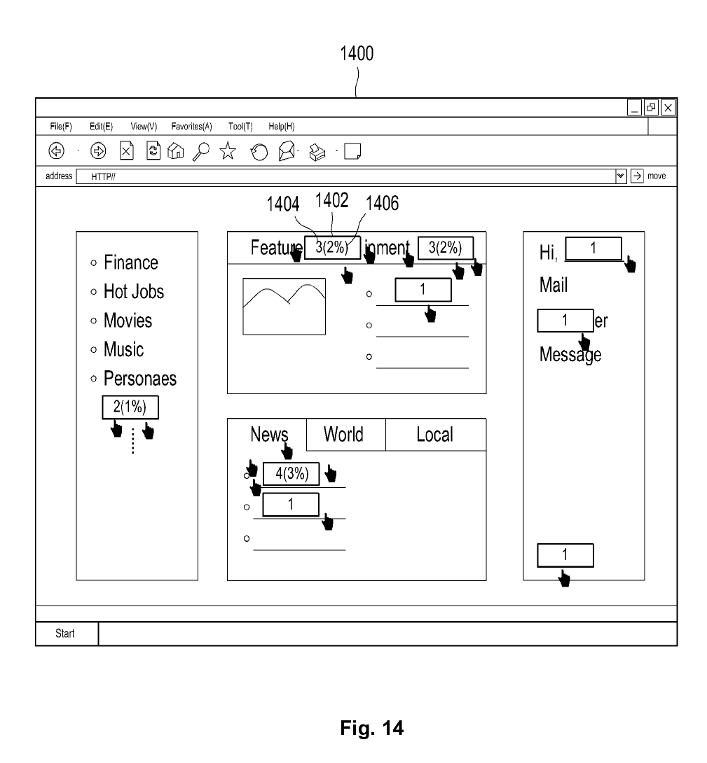

FIG. 14 illustrates a web page 1400 displayed on a screen of the administrator terminal 130 at the step 1480 in accordance with one embodiment of the present invention. As shown in FIG. 14, the pop-up window 1402 is provided for each click location in the web page 1400, which indicates the click numbers 1404 and click rate 1406. It should be noted that for purposes of simplifying the displays, while the click rate is omitted for the click location whose click number is one, the click rate is indicated together for the location whose click number is more than one. Those skilled in the art may employ a variety of other methods to display the click number and/or click rate without departing from the scope of the present invention.

As discussed above, the present invention provides web site click information using coordinate values. Thus, the exact click location can be obtained in the present invention. Further, even when a user makes a click which does not correspond to any links, the information associated with the click can be tracked. Various aspects of the present invention may also be practiced in a wide variety of network environments including, for example, TCP/IP-based networks, telecommunications networks, wireless networks, etc. In addition, the computer program instructions and data structures with which embodiments of the present invention are implemented may be stored in any type of tangible computer-readable media (e.g., RAM or ROM), and may be executed according to a variety of computing models including, for example, a client/server model, a peer-to-peer model, on a stand-alone computing device, or according to a distributed computing model in which various of the functionalities described herein may be effected or employed at different locations. The steps of the methods described herein need not be performed in the illustrated order, but may be adjusted, omitted and/or expanded without departing from the scope of the present invention.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A system for tracking web page click information, comprising:
at least one storage device having web page click information stored therein for each of a plurality of web pages, the web page click information including user information representing one or more users who visited the corresponding web page, the web page click information also including click location information representing one or more click locations selected by the one or more users in the corresponding web page, each of the one or more click locations being defined by coordinate values on a frame of reference of the corresponding web page; and
one or more computing devices configured to facilitate selection of one of the web pages, and generate a representation of the web page click information for the selected web page, the representation including at least some of the click location information.

2. The system of claim 1, wherein the web page click information further includes one or more of a URL address for the corresponding web page, object coordinate values of the one or more click locations, a time at which a corresponding click event occurred, web page code of the corresponding web page, a URL address of a web page where the one or more users visited before the corresponding webpage, or a link corresponding to at least one of the one or more click locations.

3. The system of claim 1, wherein the user information includes a cookie associated with the corresponding webpage.

4. The system of claim 1, further comprising:
a communication module for transmitting the stored web page click information to the one or more computing devices.

5. The system of claim 1, wherein the representation comprises:
a navigation pattern representation showing a change of the one or more click locations made by the one or more users in the selected web page;
a navigation route representation showing a change of web pages that the one or more users visited; and
a click rate representation showing the number of times that the one or more click locations are clicked.

6. A computer-implemented method for tracking web page click information, comprising:
presenting a web page in an interface on a user device;
generating click location information representing one or more click locations selected in the web page via the user device, each of the one or more click locations being defined by coordinate values on a frame of reference of the corresponding web page; and
transmitting the click location information to a remote device for storage with user information representing a user associated with the user device.

7. The method of claim 6, wherein the user information includes a cookie of the user associated with the user device.

8. A computer-implemented method for tracking web page click information, comprising:
storing web page click information for each of a plurality of web pages, the web page click information including user information representing one or more users who visited the corresponding web page, the web page click information also including click location information representing one or more click locations selected by the one or more users in the corresponding web page, each of the one or more click locations being defined by coordinate values on a frame of reference of the corresponding web page;
presenting a target web page selection interface to enable selection of one of the web pages; and
generating a representation of the web page click information for the selected web page, the representation including at least some of the click location information.

9. The method of claim 8, wherein the target web page selection interface further enables selection of one of the analysis options, each of the analysis options indicating a guideline for generating the representation of the web page click information for the selected web page.

10. The method of claim 9, wherein the analysis options include one or more of a navigation pattern analysis, a navigation route analysis or a click rate analysis.

11. The method of claim 10, wherein the selected analysis option is the navigation pattern analysis, and wherein the representation shows a change of the one or more click locations made by the one or more users in the selected web page

12. The method of claim 10, wherein the selected analysis option is the navigation route analysis, and wherein the representation shows a change of web pages visited by the one or more users.

13. The method of claim 10, wherein the selected analysis option is the click rate analysis, and wherein the representation shows the number of times that the one or more click locations are clicked.
